(19) United States
(12) Patent Application Publication
(10) Pub. No.: US 2020/0174717 A1
(43) Pub. Date: Jun. 4, 2020

(54) METHOD OF EDITING A PRINT DOCUMENT

(71) Applicant: Canon Production Printing Holding B.V., Venlo (NL)

(72) Inventor: Marvin P. BRUNNER, Venlo (NL)

(73) Assignee: Canon Production Printing Holding B.V., Venlo (NL)

(21) Appl. No.: 16/784,649

(22) Filed: Feb. 7, 2020

Related U.S. Application Data
(63) Continuation of application No. PCT/EP2018/072177, filed on Aug. 16, 2018.

(30) Foreign Application Priority Data
Aug. 24, 2017 (EP) 17187650.1

(51) Int. Cl. G06F 3/12

(52) U.S. Cl. CPC G06F 3/1208; G06F 3/125

(57) ABSTRACT

A method of editing a print document includes an impositioning step for determining positions of print objects in a document to be printed, the positions being determined in view of a later step of finishing the document after printing. The method includes providing document data on a client computer; sending document data to a cloud computer and requesting the cloud computer to perform the impositioning step; and sending the impositioned document data to a printer for printing the document. The method also includes splitting the document data into contents data and box information data, the box information data specifying shapes and dimensions and intended positions of the print objects; sending only the box information data to the cloud computer; and when the cloud computer has performed the impositioning step on the box information data, merging the impositioned box information data with the contents data either in the client computer or at the printer.

### CROSS REFERENCE TO RELATED APPLICATIONS

This application is a Continuation of International Application No. PCT/EP2018/072177, filed on Aug. 16, 2018, and for which priority is claimed under 35 U.S.C. § 120. PCT/EP2018/072177 claims priority under 35 U.S.C. § 119 to application Ser. No. 17/187,650.1, filed in Europe on Aug. 24, 2017. The entirety of each of the above-identified applications is expressly incorporated herein by reference.

### BACKGROUND OF THE INVENTION

### Field of the Invention

The invention relates to a method of editing a print document, comprising an impositioning step for determining positions of print objects in a document to be printed, the positions being determined in view of a later step of finishing the document after printing, the method comprising steps of:

a) providing document data on a client computer;
b) sending document data to a cloud computer and requesting the cloud computer to perform the impositioning step; and
c) sending the impositioned document data to a printer for printing the document.

### Background of the Invention

When a print document is intended to be subjected to a finishing operation such as folding, clipping and/or binding, the positions of the various print objects, e.g. images, text blocks or entire pages of the document, relative to the recording medium have to be determined such that all print objects will be found in the intended positions after the finishing operation has been completed. The process of determining the positions of the print objects in this way is termed “impositioning”. In a finisher, the specific way how the finishing operations are performed will influence the final positions of the print objects, so that knowledge about the particular properties of the finisher that is going to be used for finishing the document is necessary for performing the impositioning step correctly. Since this information may not be readily available for a creator or editor of a print job, it is convenient to outsource the impositioning step to a cloud computer on which sophisticated impositioning algorithms are implemented and in which the relevant information on the properties of the finishing apparatus is available. Technically, the cloud computer is nothing more than a remote computer that is accessible through a computer network. From a non-technical point of view, the cloud computer is often managed and made available (possibly commercially) by a third party. Often the services offered by a cloud computer are made available over the internet, either for free or against a variety of commercial terms.

Document editing operations which involve cloud computing are described for example in U.S. Pat. No. 8,769,014 B2, where a plurality of computers in a network are enabled to collaborate in editing documents.

U.S. Pat. No. 9,489,354 B1 describes a method for masking and unmasking content in a document, so that, when the document is accessible to a plurality of users, access to the contents may be limited to a group of privileged users.

It is an object of the invention to provide an improved editing method that includes an impositioning step.

### SUMMARY OF THE INVENTION

In order to achieve this object, a method according to the invention is provided wherein:

step a) comprises a sub-step of splitting the document data into contents data and box information data, the box information data specifying shapes and dimensions and intended positions of the print objects;

in step b), only the box information data are sent to the cloud computer; and

when the cloud computer has performed the impositioning step on the box information data, the impositioned box information data are merged with the contents data either in the client computer or at the printer.

The invention is based on the consideration that the contents of the print objects are not relevant for the impositioning step which requires only knowledge of the shapes and dimensions and intended positions of the print objects. This information can be provided in the form of attributes of bounding boxes of the print objects and requires only a limited data volume that, in most cases, is significantly smaller than the data volume of the contents. Since, according to the invention, only the box information data need to be transmitted from the client computer to the cloud computer, the bandwidth that is required for transmitting the necessary data is reduced significantly. This applies not only to the bandwidth required for transmitting the data from the client computer to the cloud computer but also to the bandwidth required for re-transmitting the impositioned data from the cloud computer back to the client computer or directly to the printer. The relatively large data volume of the contents data needs to be transmitted only from the client computer to the printer. In many cases both, the client computer and the printer will be installed in the same user premises, so that the transmission of the contents data (possibly via a direct wire connection) will not increase the traffic on a data network at all.

Another significant advantage of the invention is an improved data safety, because the sensitive contents data may remain in the premises of the user and need not be transmitted to and from the cloud computer and will therefore be less vulnerable to hacker attacks or adverse actions in case of an untrusted cloud computer.

Another advantage is that there is no possibility that the contents data are altered during the processing in the cloud computer, so that the operator of the cloud computer cannot be blamed for any possible errors that relate to the contents data.

More specific optional features of the invention are indicated in the dependent claims.

In one embodiment, the impositioned box information data will be retransmitted from the cloud computer to the client computer, where they are merged with the contents data. In this case the user at the client computer has the possibility to watch a preview of the print job, e.g. in the form of a read spread showing the final result after finishing or in the form of a print spread showing the printed media sheet before finishing, and the user may then decide on the basis of the preview whether or not the job is sent to the printer. It will also be possible for the user to edit the contents data even after the impositioned box information data have been received from the cloud computer.

In a modified embodiment, it is possible that the impositioned box information data are sent directly from the cloud computer to the printer, whereas the client computer sends only the contents data which are merged with the box information data at the printer.

### BRIEF DESCRIPTION OF THE DRAWINGS

Embodiment examples will now be described in conjunction with the drawings, wherein:

FIG. 1 is a schematic view of document data stored on a client computer;

FIG. 2 illustrates a process of splitting the document data into box information data and contents data in the client computer;

FIG. 3 illustrates a step of transmitting the box information data to a cloud computer;

FIG. 4 illustrates a step of retransmitting impositioned box information data to the client computer and merging them again with the contents data;

FIG. 5 illustrates a step of sending the merged document data to a printer;

FIG. 6 is a view of a finished print document; and

FIG. 7 illustrates a modified embodiment of the invention.

### DETAILED DESCRIPTION OF THE PREFERRED EMBODIMENTS

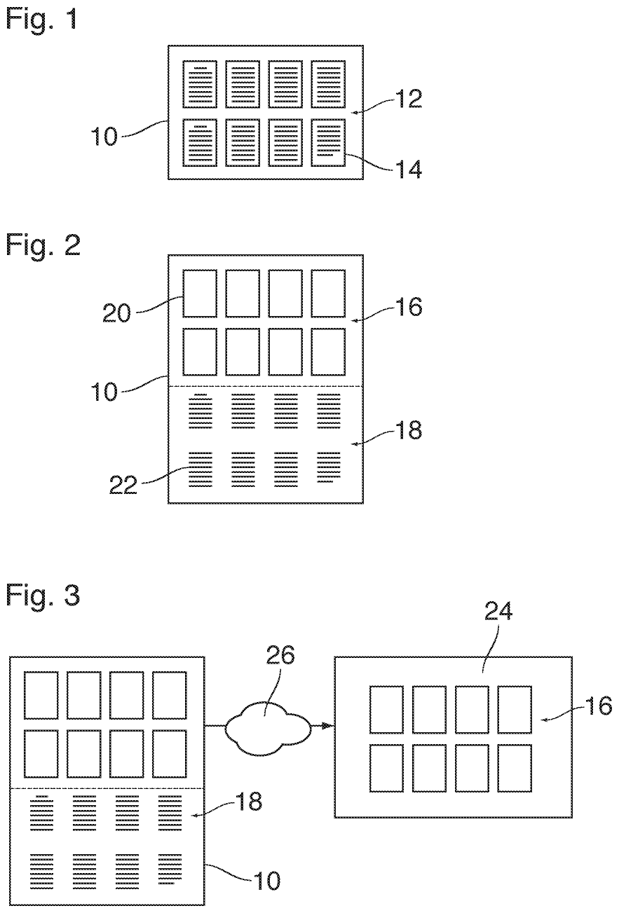

FIG. 1 schematically shows a client computer 10 on which document data 12 of a print document have been created and/or stored. In the example shown the print document comprises eight print objects 14, text pages in this example, which are to be printed on a common media sheet which will then be folded and bound in order to finally obtain a print product in the form of a booklet or brochure.

Implemented on the client computer 10 is splitting software which is capable of splitting the document data 12 into box information data 16 and contents data 18, as has been shown in FIG. 2. The box information data 16 comprises only the shapes and dimensions of bounding boxes 20 of the print objects 14 (pages) as well as information on the positions which the corresponding objects are intended to finally assume in the print product. The contents 22, i.e. the text to be printed on the various pages of the document in this example, is stored in a separate file.

As is shown in FIG. 3, the client computer 10 is connected to a cloud computer 24 via a data network 26. FIG. 3 specifically illustrates a step in which the box information data 16 are transmitted from the client computer 10 to the cloud computer 24, whereas the contents data 18 are kept only in the client computer.

Along with the box information data 16, the client computer 10 transmits to the cloud computer 24 also a request to subject the box information data 16 to an impositioning step for determining the positions in which the print objects 14 have to be printed on the media sheet in order to assure that, after finishing, the print objects will assume the intended positions in the final print product. It will be understood that finishing operations such as folding, trimming and binding will alter the positions of the print objects 14 as well as page programming operations such as “force page left” and “force page right” which are considered finishing operations herein for the sake of simplicity. For example, when several layers of a media sheet are folded along a common fold line and bound into a booklet, the non-neglectable thickness of the media sheet causes a shift of the print objects in one layer relative to the corresponding objects in the next layer, a phenomenon that is known as “creep”. The purpose of the impositioning step is to compensate effects of this kind (“creep compensation”).

The cloud computer 24 has access to information specifying the properties of commonly used types of finishing apparatus and is loaded with specific impositioning software that is capable of predicting the shifts of the print objects resulting from the various finishing operations and to determine the print positions of the print objects 14 on the media sheet such that the positional shifts in the finishing operations are compensated. To that end, the client computer 10 transmits also information identifying the finisher that is going to be used for finishing the print product.

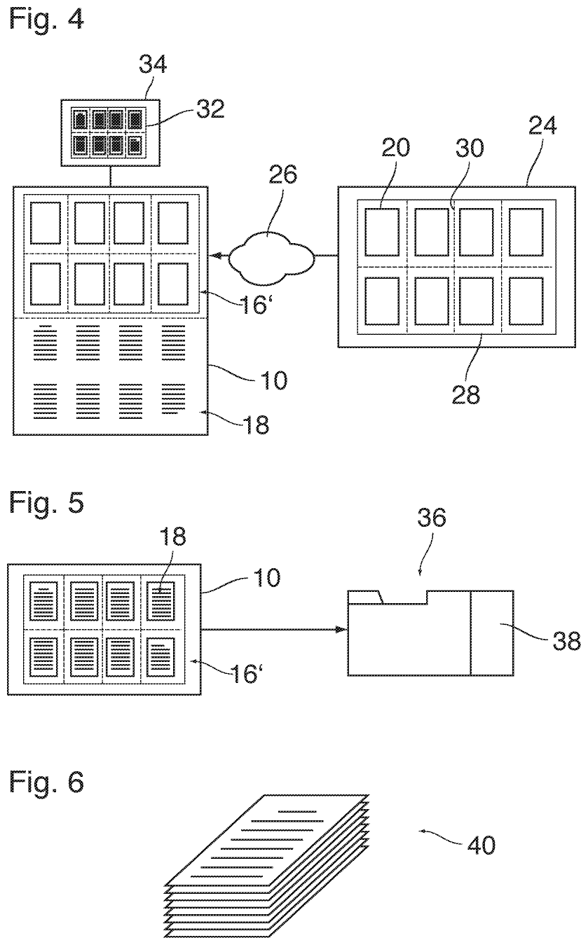

FIG. 4 illustrates a stage in which the cloud computer 24 has completed the impositioning step and has determined the positions of the bounding boxes relative to the edges of a media sheet 28 and relative to fold lines 30 which will be formed in the sheet in a finishing (folding) operation. The result of this impositioning step, i.e. the required positions of the print objects on the media sheet 28 have already been transmitted back to the client computer 10 as a file of impositioned box information data 16′. The client computer 10 merges the impositioned box information data 16′ with the contents data 18 and optionally shows a preview 32 of the print document on a display 34. In order to facilitate merging the impositioned box information data 16′ with the contents data 18, the client computer 10 provided the box information data 16 with identifiers allowing each bounding box 20 be associated with the corresponding contents 22, and subsequently the cloud computer 24 provides the impositioned box information data 16′ again with the identifiers resulting in each bounding box 20 to be associated with the corresponding contents 22. After the merge the user may still edit or correct the contents of the print objects at the client computer as long as such changes do not affect the bounding boxes 20, which can be checked by the client computer 10. An example is correcting typos, spelling errors, etc.

FIG. 5 shows a step in which the impositioned box information data 16′ merged with the contents data 18 are transmitted from the client computer 10 to a printer 36 which is combined with a finisher 38 for printing and finishing the print product.

FIG. 6 is a view of the finished print product 40.

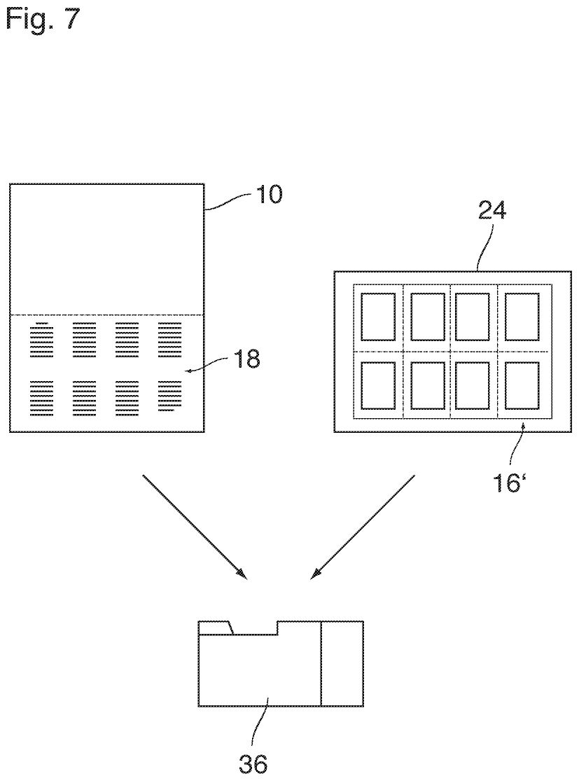

Rather than transmitting the impositioned box information data 16′ from the cloud computer 24 to the client computer 10 and then sending the merged document data to the printer 36, it is also possible that the impositioned box information data 16′ are sent directly from the cloud computer 24 to the printer 36, as has been shown in FIG. 7. In that case, the contents data 18 are transmitted separately from the client computer 10 to the printer 36, and the job processing software in the printer 36 is configured to merge the box information data and the contents data.

What is claimed is:

1. A method of editing a print document, comprising an impositioning step for determining positions of print objects in a document to be printed, the positions being determined in view of a later step of finishing the document after printing, the method comprising steps of:
a) providing document data on a client computer;
b) sending document data to a cloud computer and requesting the cloud computer to perform the impositioning step; and
c) sending the impositioned document data to a printer for printing the document; wherein:
step a) comprises a sub-step of splitting the document data into contents data and box information data, the box information data specifying shapes and dimensions and intended positions of the print objects;
in step b), only the box information data are sent to the cloud computer; and
when the cloud computer has performed the impositioning step on the box information data, the impositioned box information data are merged with the contents data either in the client computer or at the printer.

2. A printing system comprising a printer, a finisher, a client computer and a cloud computer, wherein the client computer and the cloud computer are configured to perform, together, the method according to claim 1.

3. The printing system according to claim 2, wherein the client computer is configured to merge the impositioned box information data with the contents data.

4. The printing system according to claim 3, wherein the client computer has input/output means permitting a user to edit the contents data independently of the box information data.

5. A software product comprising program code on a computer-readable, non-transitory medium, the program code, when loaded into a computer, causing the computer to perform the steps of the method according to the claim 1 that are to be performed by the client computer.

6. A software product comprising program code on a computer-readable, non-transitory medium, the program code, when loaded into a computer, causing the computer to perform the steps of the method according to the claim 1 that are to be performed by the cloud computer.
